(19) United States
(12) Patent Application Publication
(10) Pub. No.: US 2012/0123004 A1
(43) Pub. Date: May 17, 2012

(54) FLAME RETARDED,THEMOPLASTIC COMPOSITION, PROCESS FOR MAKING SAME AND ARTICLE CONTAINING SAME

(76) Inventors: Jeffrey Stowell, Wingdale, NY (US); Ronald Pirrelli, Mahopac, NY (US); Sophia Dashevsky, Monroe Township, NJ (US)

(21) Appl. No.: 13/145,677

(22) PCT Filed: Feb. 2, 2010
(86) PCT No.: PCT/US2010/022865

§ 371 Date: Sep. 23, 2011

Related U.S. Application Data
(60) Provisional application No. 61/207,159, filed on Feb. 9, 2009.

(51) Int. Cl. C08L 75/04; C08J 9/00; C09K 21/12; C08K 5/527

(52) U.S. Cl. 521/107; 524/710; 521/170; 252/609

(57) ABSTRACT

There is provided herein a composition comprising:
(a) a flexible polyurethane foam-forming mixture and;
   an effective flame retarding amount of at least one non halogen-containing cyclic phosphate ester of the general formula (I):

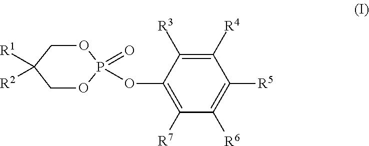

wherein R¹ and R², are the same or different, linear or branched alkyl group containing from up to about 10 carbon atoms, optionally containing heteroatom substituents, provided that R¹ and R² are not both methyl; and R³-R⁷ are each independently hydrogen or the same or different linear or branched alkyl group containing up to about 4 carbon atoms, optionally containing heteroatom substituents; provided that the cyclic phosphate ester is a liquid or is substantially soluble in at least one different liquid flame retardant and/or the hydroxyl-containing component of the flexible polyurethane foam-forming mixture; the cyclic phosphate ester of formula (I) contains at least 8.5 weight percent phosphorous based on the total weight of any phosphorous containing component(s); and, provided that the composition is in the absence of melamine compound. There is also provided a flame retardant additive composition comprising the cyclic phosphate ester of formula (I) and at least one different liquid flame retardant. Further, there is provided a process of making a flame retarded polyurethane foam mixture.

### FIELD OF THE INVENTION

The present invention relates to flame-retardant additives for incorporation in flexible polyurethane foam-forming mixtures. More particularly, the invention relates to cyclic phosphate ester(s) and, optionally additional phosphate ester(s), and the use of such ester(s) as a flame-retardant additive(s) in polyurethane foam.

### BACKGROUND OF THE INVENTION

Flame-retardant additives are often used to reduce the risk and severity of polyurethane foam combustion. A wide variety of flame retardants are known and commercially available for this purpose. However, there are often considerable technical problems and toxicological concerns restricting the use of these flame retardants.

Flexible polyurethane foams are widely used as cushioning or padding materials, for example, in furniture and in automobiles. Flame retardants are generally incorporated into such foams. However, it is difficult to identify flame retardants which will achieve adequate flame retardancy economically without impacting negatively on the physical properties of polyurethane foams and which are environmentally friendly.

Flame-retardant additives commonly used to make flame retarded polyurethane foams typically contain halogen compounds. However, for reasons of product sustainability there is a movement within the industry towards the use of non halogen-containing flame retardants.

Additionally, in order to be commercially acceptable, flame-retarded polyurethane foams must pass certain flame retardancy tests depending upon the application of the foam. While some tests are less stringent than others, it is desirable that the flame-retarded foam pass the more stringent tests, as well as the less stringent, and therefore be useful for all applications.

The use of phosphate flame-retardants is known. For example, U.S. Pat. No. 5,750,601 discloses flame retardant polymeric compositions, such as polyester-polyurethane foam, containing halogen-free cyclic phosphoric acid esters, i.e., phenyl and alkyl-substituted phenyl neopentyl cyclic phosphate ester flameproofing agents. WO 2008/118154 describes a mixture of cyclic phosphate ester and melamine compound(s) and the use of such mixtures as a flame-retardant for polyurethane foams. U.S. Pat. No. 6,734,239 discloses resins, e.g., polyurethane foams, containing phosphorinane-type phosphates, which can be used with other additives, such as melamine, as flame retardants. Unfortunately such phosphates have either a high degree of crystallinity negatively affecting the physical properties of polyurethane foams or volatility which makes them unsuitable for use in polyurethane foam applications where the foam is subjected to oven aging prior to flame retardancy testing (i.e., the California TB 117 test) as well as in automobile applications where volatility is of major significance. Additionally, the process for making the phosphates of U.S. Pat. No. 6,734,239 is not commercially viable. The alkyl esters as disclosed in U.S. Pat. No. 6,734,239 promote higher levels of discoloration (scorch) when making polyurethane foam than other known low-scorch products.

The desire, however, for polyurethane foam products containing flame retardants which are environmentally friendly and economical and at the same time are capable of meeting or exceeding the most stringent flame retardancy standards still remains.

### SUMMARY OF THE INVENTION

The present invention relates to a composition comprising:

(a) a flexible polyurethane foam-forming mixture and;

(b) an effective flame retarding amount of at least one non halogen-containing cyclic phosphate ester of the general formula (I):

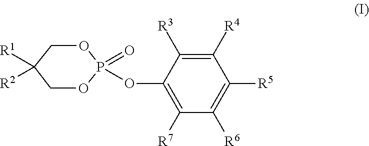

wherein R¹ and R², are the same or different, linear or branched alkyl group containing up to about 10 carbon atoms, provided that R¹ and R² are not both methyl, optionally containing heteroatom substituents; and R³-R⁷ are each independently hydrogen or the same or different linear or branched alkyl group containing up to about 4 carbon atoms, optionally containing heteroatom substituents; provided that the cyclic phosphate ester is a liquid or is substantially soluble in at least one different liquid flame retardant and/or the hydroxyl-containing component of the flexible polyurethane foam-forming mixture; and, provided that the composition contains at least 8.5 weight percent phosphorous based on the total weight of any phosphorous containing component(s) and the composition is in the absence of a melamine compound.

In another embodiment herein there is provided a flame retardant additive composition comprising an effective flame retarding amount of a mixture of

(a) at least one non halogen-containing cyclic phosphate ester of the general formula (I):

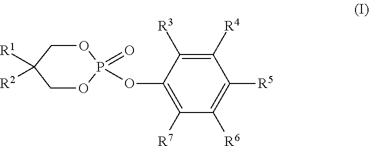

wherein R¹ and R², are the same or different, linear or branched alkyl group containing up to about 10 carbon atoms, provided that R¹ and R² are not both methyl, optionally containing heteroatom substituents; and R³-R⁷ are each independently hydrogen or the same or different linear or branched alkyl group containing up to about 4 carbon atoms, optionally containing heteroatom substituents; and,

(b) at least one different liquid flame retardant; provided that the cyclic phosphate ester of formula (I) is a liquid or is substantially soluble in the at least one different liquid flame retardant and/or a hydroxyl-containing component of a flexible polyurethane foam-forming mixture; and, provided that the flame retardant additive composition is in the absence of a melamine compound and the flame retardant additive composition contains at least 8.5 weight percent phosphorous based on the total weight of any phosphorous containing component(s).

It will be understood herein that a flexible polyurethane foam-forming mixture is not a requisite component of the flame retardant additive composition.

The present invention also relates to a process of making a flame retarded flexible polyurethane foam mixture comprising contacting a flexible polyurethane foam-forming mixture and an effective flame retarding amount of at least one non halogen-containing cyclic phosphate ester having the general formula (I):

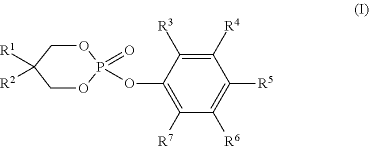

wherein R¹ and R², are the same or different, linear or branched alkyl group containing up to about 10 carbon atoms, optionally containing heteroatom substituents, provided that R¹ and R² are not both methyl; and R³-R⁷ are each independently hydrogen or the same or different linear or branched alkyl group containing up to about 4 carbon atoms, optionally containing heteroatom substituents; provided that the cyclic phosphate ester is a liquid or is substantially soluble in a different liquid flame retardant and/or the hydroxyl-containing component of the flexible polyurethane foam-forming mixture; which contacting forms said flame retarded flexible polyurethane foam mixture; and, provided that the flame retarded flexible polyurethane foam mixture is in the absence of melamine compound and the flame retarded foam mixture contains at least 8.5 weight percent phosphorous based on the total weight of any phosphorous containing component(s).

### DETAILED DESCRIPTION OF THE INVENTION

The expression “melamine compound(s)” as used herein includes melamine per se, i.e., the compound 2,4,6-triamino s-triazine, and its flame retardant-effective derivatives. Melamine and its derivatives are those compounds having at least one 6-membered triazine ring or moiety therein in which at least one amino nitrogen atom is directly bonded to at least one such triazine ring on a carbon atom of the ring. When the melamine compound contains more than one such ring or moiety, the rings or moieties can be in the form of fused ring structures (as in melem or melon) or unfused ring structures (as in melam).

Neopentyl cyclic phosphate esters are highly crystalline in nature, and as a result, are relatively insoluble in a flexible polyurethane foam matrix at normal atmospheric temperatures. The crystalline neopentyl cyclic phosphate esters are believed to melt upon exposure to the heat of foam production and then resolidify in the foam upon foam cooling. Foam containing such a neopentyl cyclic phosphate ester has an undesirable crunchy feel upon first handling, and upon every subsequent handling following a heating and cooling of the foam. In addition, since compression set testing of flexible foam calls for the foam to be heated and cooled under compression, compressed foam containing a neopentyl cyclic phosphate ester that is allowed to cool, prior to complete recovery, will not fully recover. As neopentyl cyclic phosphate ester resolidifies in the foam, it holds the foam in a compressed state until the samples are again heated. Low-density flexible foam is particularly vulnerable to this physical problem. In addition, there are various other physical problems, e.g., processing problems, associated with using a solid flame retardant such as crystalline neopentyl cyclic phosphate ester, or likewise, other cyclic phosphate esters which are non-liquid and/or are not substantially soluble in different liquid flame retardants and/or the hydroxyl-component of a flexible polyurethane foam-forming mixture, as well as in the use of solid compounds such as melamine compound(s), on a commercial scale. For example, these physical problems can comprise problems of solid handling, maintaining and feeding a solid suspension, solids plugging CO₂ foam screens and the like.

In accordance with the present invention, it has unexpectedly been found that the inventive composition, as described herein, is capable of being used to produce a flame retarded flexible foam capable of meeting a variety of flame retardancy standards, e.g., the California Technical Bulletin 117 test criteria, and the Motor Vehicle Safety Standard 302 (MVSS 302) test criteria, (as well as those other standards described herein) as well as avoid the above-noted physical problems. Surprisingly, such advantages are maintained in the substantial absence of melamine compound(s). In furtherance of the present invention, it has been surprisingly found that certain cyclic phenyl phosphate esters, as more fully described herein below, when added to flexible polyurethane foam-forming mixtures, provide effective flame-retardant results and provides flexible polyurethane foam which meet and/or exceed various flame-retardant test criteria as well as avoid the noted physical problems. In addition, it has been further surprisingly found that a blend of such certain cyclic phenyl phosphate esters with at least one other different liquid flame retardant, e.g., phosphorous-based flame retardants, provides an extended temperature range at which the cyclic phenyl phosphate esters can be used and stored as a liquid (i.e., the blend of cyclic phenyl phosphate esters with a different liquid flame retardant remain in solution (that is they do not precipitate out) at lower temperatures) and additionally, can displace some of the higher cost of the cyclic phenyl phosphate esters, as compared to the sole use of such cyclic phosphate ester. In addition, such a blend of cyclic phenyl phosphate ester(s) with at least one other different liquid flame retardant can avoid the noted physical problems associated with the incorporation of a solid material such as melamine compound(s). Further, it has been unexpectedly discovered that the use of the cyclic phosphate ester(s) of formula (I) with the additional different liquid flame retardant can avoid the cyclic phosphate ester of formula (I) being undesirably solidified (thickened through precipitation of the cyclic phosphate ester) at lower temperatures, i.e., below 25 degrees Celsius, and preferably below 20 degrees Celsius, and most preferably below 10 degrees Celsius, and as low as zero degrees Celsius. This is an advantage in that often commercial end users of such flame retardant compositions store such compositions at such lower temperatures, which may in certain situations result in the stated thickening/solidification absent such blending of additional different liquid flame-retardant. The use of additional different liquid flame retardant as described herein enables the user to store such flame retardant compositions in their liquid state at the stated lower temperatures, while additionally lowering the cost of such a composition as compared to a composition composed of solely the cyclic phosphate ester of formula (I) and while still maintaining favorable physical properties in the polyurethane foam in which it is employed.

In another advantageous embodiment herein in the blend of cyclic phosphate ester (I) and a different flame retardant such a blend does not have any solids precipitate out at low temperatures, e.g., below 25 degrees Celsius, preferably at zero degrees Celsius.

The phenyl and substituted phenyl cyclic phosphate esters of formula (I) avoid the above-described disadvantages of the non-phenyl moiety containing cyclic phosphate esters described in U.S. Pat. No. 6,734,239. For example, the phosphate esters of formula (I) of the present invention have a lower volatility than the corresponding alkyl esters (wherein the phenyl group of the present invention is replaced with an alkyl moiety such as in U.S. Pat. No. 6,734,239) thus, giving the cyclic phosphate esters of formula (I) herein a distinct advantage in applications where chemical volatility is integral. Further, the cyclic phosphate esters of formula (I) provide less discoloration (scorch) when making polyurethane foam as compared to the use of the alkyl esters disclosed in U.S. Pat. No. 6,734,239; an explanation for this can in part be rationalized using a commonly accepted mechanism for foam discoloration entailing the alkylation and subsequent oxidation of aromatic amines formed during the flexible foam making process by the flame retardant, which is not of issue in the present invention due to the presence of the phenyl moiety instead of the alkyl moiety of U.S. Pat. No. 6,734,239.

The cyclic phosphorus esters of the invention are compounds that contain a phosphorinane ring structure and are useful as flame retardants in compositions, e.g., polyurethane foams, specifically flexible polyurethane foams, and more specifically low-density flexible polyurethane foams.

In particular, the cyclic phosphate esters of the present invention are represented by the general formula (I):

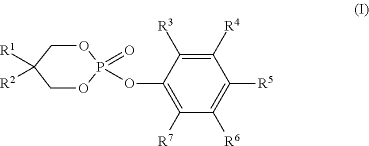

In formula (I), R¹ and R², are the same or different, linear or branched alkyl group containing up to about 10 carbon atoms, optionally containing heteroatom substituents, e.g., O, N, S, and the like, provided that not both R¹ and R² are methyl. It will be understood herein that the composition herein which includes formula (I) above does not include species that would not meet the stated proviso that such cyclic phosphate ester is a liquid or is substantially soluble in at least one different liquid flame retardant and/or the hydroxyl-containing component of the flexible polyurethane foam-forming mixture. Such a structure of formula (I) which would not meet such a proviso would be for example, where R¹ and R² are both ethyl, and the like.

Examples of R¹ and R² include linear alkyl groups such as methyl, ethyl, n-propyl, n-butyl, n-pentyl, n-hexyl, and branched alkyl groups such as iso-propyl, iso-butyl, sec-butyl, tert-butyl, iso-pentyl, tert-pentyl, neo-pentyl, iso-hexyl, and the like. In one embodiment herein, R¹ and R² are linear alkyl groups having from 1 to 9 carbon atoms, preferably from 2 to 9 carbon atoms, even more preferably from 2 to 6 carbon atoms, with R¹ being ethyl and R² being butyl being most preferred.

In formula (I), R³-R⁷ are each independently hydrogen or the same or different linear or branched alkyl group containing up to about 4 carbon atoms, optionally containing heteroatom substituents, e.g., O, N, S, and the like. Preferably, R³-R⁷ are each independently hydrogen, methyl, isopropyl or butyl. In one embodiment each of R³-R⁷ are hydrogen.

The cyclic phosphate esters (I) of the present invention may contain impurities derived from by-products and unreacted materials during production, but may be used as flame retardants without being further purified so long as the impurities do not affect the flame retardancy of flexible polyurethane foam made from the inventive composition(s) herein.

The composition and flame retardant additive composition of the present invention can include one or more species of cyclic phosphate esters (I). It is understood herein that the use of the expression “cyclic phosphate ester(s) of formula (I)” maintains the above-described provisos to such a structure, specifically the provisos that the cyclic phosphate ester is a liquid or is substantially soluble in at least one different liquid flame retardant and/or the hydroxyl-containing component of the (or a) flexible polyurethane foam-forming mixture; and, provided that the composition or flame retardant additive composition is in the absence of melamine compound(s); and the composition or flame retardant additive composition contains at least 8.5 weight percent phosphorous based on the total weight of any phosphorous containing component(s) therein.

The composition of the present invention can further comprise a different liquid flame retardant, preferably, a different liquid non-halogenated flame retardant, which is different from the cyclic phosphate ester of formula (I). The expression “different from the cyclic phosphate ester of formula (I) is understood to be any liquid flame retardant that is outside the scope of the definition of the cyclic phosphate ester of formula (I).

“Substantially soluble” as used herein is understood to mean full solubility of the cyclic phosphate ester of formula (I) in the different liquid flame retardant and/or the (or a) hydroxyl-containing component of the flexible polyurethane foam-forming mixture, at about 0 degrees Celsius and above, preferably complete solubility at about 0 degrees Celsius to about 50 degrees Celsius and most preferably from about 0 degrees Celsius to about ambient temperatures, i.e., about 25 degrees Celsius. In another embodiment substantially soluble can mean full solubility of the cyclic phosphate ester of formula (I) in the different liquid flame retardant and/or the (or a) hydroxyl-containing component of the flexible polyurethane foam-forming mixture, at temperatures from as low as 10 degrees below zero Celsius up to about 25 degrees Celsius. Such a temperature range can be used in any of the other embodiments herein. It will further be understood herein that any ranges herein can comprise any subranges therebetween or any combination of endpoints of such ranges.

“Liquid” as used herein is understood to be a substance that is in the liquid phase when it is at least about 25 degrees Celsius, preferably is liquid from about zero degrees Celsius up to about 25 degrees Celsius and above

In one non-limiting embodiment, in the instance of a cyclic, phosphate ester of formula (I), which is a liquid, the liquid cyclic phosphate ester of formula (I) can be fully solvated by the at least one different liquid flame retardant and/or the hydroxyl-containing component of the flexible polyurethane foam-forming composition at about ambient temperature and above, as well as those temperature ranges recited above for the phrase “substantially soluble”. In one embodiment full solvation is understood as to comprise no phase separation, e.g. no oil and aqueous phase separation of the components of the mixture. In another embodiment, full solvation is understood to comprise no precipitation of solid cyclic phosphate ester at low temperatures such as from zero degrees Celsius up to about 25 degrees Celsius in a blend with the at least one different liquid flame retardant and/or the hydroxyl-containing component of the flexible polyurethane foam-forming composition at about ambient temperature and above, as well as those temperature ranges recited above for the phrase “substantially soluble”.

It will be understood herein that when the cyclic phosphate ester of formula (I) is a liquid, it is miscible with the at least one different liquid flame retardant and/or the hydroxyl-containing component of the (or a) flexible polyurethane foam-forming composition. In one embodiment herein the miscibility of the liquid cyclic phosphate ester of formula (I) with the at least one different liquid flame retardant and/or the (or a) hydroxyl-containing component of the flexible polyurethane foam-forming mixture, is sufficient miscibility as to not impair the flame-retardant properties, or physical properties as described herein, of the flexible polyurethane foam produced from the inventive composition or the inventive flame retardant additive composition, as compared to a composition or flame retardant additive composition which does not contain the cyclic phosphate ester of formula (I).

The at least one different liquid flame retardant which can be present in the composition and flame retardant additive composition of the invention can be any liquid flame retardant which is different from that described in formula (I) but, preferably, is selected from the group consisting of, but not limited to phosphorous-based flame retardants, preferably non-halogenated phosphorous-based flame retardants, such as those selected from the group consisting of alkyl phosphates, aryl phosphates, alkyl aryl phosphates, alkaryl phosphates, aromatic bisphosphates, oligomeric phosphates, phosphonates, and combinations thereof. Preferably the at least one different liquid flame retardant is selected from the group consisting of triethyl phosphate, diethyl ethylphosphonate, tris(2-butoxyethyl) phosphate, dibutyl phenyl phosphate, butyl diphenyl phosphate, 2-ethylhexyl diphenyl phosphate, isodecyl diphenyl phosphate, cresyl diphenyl phosphate, triphenyl phosphate, tricresyl phosphate, butylated or isopropylated triphenyl phosphate and combinations thereof.

In addition to, or alternatively to, the different liquid non-halogenated flame retardant described above, the incorporation of different liquid halogenated flame retardant can also or alternatively be used, e.g., tris(chloropropyl) phosphate, tris(dichloroisopropyl) phosphate and 2,2-bis(chloromethyl)trimethylene bis(bis(2-chloroethyl) phosphate), and the like, and mixtures thereof.

The composition and flame retardant additive composition of the present invention preferably comprises at least one non halogen-containing cyclic phosphate ester of the formula (I) herein. The ratio of weight percents in the composition and flame retardant additive composition herein of cyclic phosphate ester(s) of formula (I) to total different liquid flame retardant(s) (when different flame retardant is optionally present in the composition or as it is present in the flame-retardant additive composition) can vary, and can range from about 5/95 to about 95/5, respectively, and preferably from about 20/80 to about 80/20, respectively, and most preferably from about 25/75 to about 75/25, respectively.

In one embodiment herein in formula (I), R¹ and R² can be, ethyl and butyl respectively, or, propyl and methyl, respectively, and such compounds of formula (I) with those respective combinations of R¹ and R² can be used in a blend with a butylated aryl phosphate, a propylated aryl phosphate, or a methylated aryl phosphate. In one embodiment such a butylated aryl phosphate could be t-butyl substituted. In one other embodiment such a propylated aryl phosphate could be isopropyl-substituted,

According to one embodiment of the invention, the flexible polyurethane foam comprises cyclic phosphate ester(s) of the formula (I) in the amount ranging from about 1 to about 20 weight percent of the total weight of the flexible polyurethane foam, and in another embodiment from about 3 to about 18 weight percent of the total weight of the flexible polyurethane foam. In yet another embodiment of the invention, the flexible polyurethane foam comprises cyclic phosphate ester(s) of the formula (I) in the amount ranging from about 5 to about 15 weight percent of the total weight of the flexible polyurethane foam.

Flexible polyurethane foam-forming mixture(s), simply stated, when reacted form flexible polyurethane foam by a condensation reaction of an isocyanate component, e.g., diisocyanate, with a hydroxyl-containing component, e.g., polyol, and a catalyst. In one non-limiting embodiment herein, the flexible polyurethane foam forming mixture can be a thermoplastic flexible polyurethane foam forming mixture and the flexible polyurethane foam formed therefrom can be a thermoplastic flexible polyurethane foam. The polyols employed in the production of flexible polyurethane foams contain reactive hydrogen atoms. The polyols are hydroxy-functional chemicals or polymers covering a wide range of compositions of varying molecular weights and hydroxy functionality. These polyhydroxyl compounds are generally mixtures of several components although pure polyhydroxyl compounds, i.e. individual compounds, may in principle be used. The polyol herein can comprise those polyols described in WO 2008/118154A2 the contents of which are incorporated by reference herein in their entirety.

The present invention is directed to flexible polyurethane foam produced from a flexible polyurethane foam-forming mixture comprising polyol, which is defined herein to be a normally liquid polymer possessing hydroxyl groups. Further, the polyol can be at least one of the type generally used to prepare flexible polyurethane foams, e.g., a polyether polyol having a molecular weight of from about 18 to about 10,000. The term “polyol” includes linear and branched polyethers (having ether linkages), polyesters and blends thereof, and comprising at least two hydroxyl groups.

Suitable polyols include polyether polyol, polyester polyol, polyetherester polyols, polyesterether polyols, polybutadiene polyols, acrylic component-added polyols, acrylic component-dispersed polyols, styrene-added polyols, styrene-dispersed polyols, vinyl-added polyols, vinyl-dispersed polyols, urea-dispersed polyols, and polycarbonate polyols, polyoxypropylene polyether polyol, mixed poly (oxyethylene/oxypropylene) polyether polyol, polybutadiene diols, polyoxyalkylene dials, polyoxyalkylene triols, polytetramethylene glycols, polycaprolactone dials and triols, and the like, all of which possess at least two primary hydroxyl groups. In one embodiment, some specific examples of polyether polyol are polyoxyalkylene polyol, particularly linear and branched poly (oxyethylene) glycol, poly (oxypropylene) glycol, copolymers of the same and combinations thereof. Graft or modified polyether polyols, typically called polymer polyols, are those polyether polyols having at least one polymer of ethylenically unsaturated monomers dispersed therein. Non-limiting representative modified polyether polyols include polyoxypropylene polyether polyol into which is dispersed poly (styrene acrylonitrile) or polyurea, and poly (oxyethylene/oxypropylene) polyether polyols into which is dispersed poly (styrene acrylonitrile) or polyurea. Graft or modified polyether polyols comprise dispersed polymeric solids. Suitable polyesters of the present invention, include but are not limited to aromatic polyester polyols such as those made with phthalic anhydride (PA), dimethyl terephthalate (DMT) polyethylene terephthalate (PET) and aliphatic polyesters, and the like.

The polyol can have a functionality of from about 2 to about 12, and preferably the polyol has a functionality of at least 2.

In one embodiment of the present invention, polyurethane foam-forming mixture comprises polyether polyol having a hydroxyl number of from about 10 to about 4000. In another embodiment of the present invention, polyether polyol has a hydroxyl number of from about 20 to about 2,000. In yet another embodiment polyether polyol has a hydroxyl number of from about 30 to about 1,000. In still another embodiment polyether polyol has a hydroxyl number of from about 35 to about 800.

The isocyanate component, e.g., polyisocyanate, of the present invention, includes any isocyanate or diisocyanate that is commercially or conventionally used for production of polyurethane foam. In one embodiment of the present invention, the isocyanate component can be an organic compound that comprises at least two isocyanate groups and generally will be any of the known aromatic or aliphatic diisocyanates.

In one embodiment, the isocyanate components that are useful in the polyurethane foam-forming mixture of this invention are organic polyisocyanate compounds that contain at least two isocyanate groups and generally will be any of the known aromatic or aliphatic polyisocyanates. According to one embodiment of the present invention, the polyisocyanate can be a hydrocarbon diisocyanate, (e.g. alkylene diisocyanate and arylene diisocyanate), such as toluene diisocyanate, diphenylmethane isocyanate, including polymeric versions, and combinations thereof. In yet another embodiment of the invention, the polyisocyanate can be isomers of the above, such as methylene diphenyl diisocyanate (MDI) and 2,4- and 2,6-toluene diisocyanate (TDI), well as known triisocyanates and polymethylene poly(phenylene isocyanates) also known as polymeric or crude MDI and combinations thereof. Non-limiting examples of isomers of 2,4- and 2,6-toluene diisocyanate include Mondur® TDI, Papi 27 MDI and combinations thereof.

In one embodiment of the invention, the polyisocyanate can be at least one mixture of 2,4-toluene diisocyanate and 2,6-toluene diisocyanate wherein 2,4-toluene diisocyanate is present in an amount of from about 80 to about 85 weight percent of the mixture and wherein 2,6-toluene diisocyanate is present in an amount of from about 20 to about 15 weight percent of the mixture.

The amount of polyisocyanate included in polyurethane foam-forming mixture relative to the amount of other materials in polyurethane foam-forming mixture is described in terms of “Isocyanate Index.” “Isocyanate Index” means the actual amount of polyisocyanate used divided by the theoretically required stoichiometric amount of polyisocyanate required to react with all active hydrogen in flexible polyurethane foam-forming mixture multiplied by one hundred (100). In one embodiment of the present invention, the Isocyanate Index in the flexible polyurethane foam-forming mixture used in the process herein is of from about 60 to about 300, and in another embodiment, of from about 70 to about 200 and in yet another embodiment, of from about 80 to about 120.

Catalysts for the production of the flexible polyurethane foams are known in the art and can be a single catalyst or mixture of catalysts such as those commonly used to catalyze the reactions of polyol and water with polyisocyanates to form flexible polyurethane foam. It is common, but not required, to use both an organoamine and an organotin compound for this purpose. Other metal catalysts can be used in place of, or in addition to, organotin compound. Suitable non-limiting examples of flexible polyurethane foam-forming catalysts include (i) tertiary amines, (ii) strong bases such as alkali and alkaline earth metal hydroxides, (iii) acidic metal salts of strong acids, (iv) chelates of various metals, (v) alcoholates and phenolates of various metals, (vi) salts of organic acids, (vii) organometallic derivatives of tetravalent tin; and combinations thereof. In one embodiment organotin compounds that are dialkyltin salts of carboxylic acids, can include the non-limiting examples of dibutyltin diacetate, dibutyltin dilaurate, dibutyltin maleate, dilauryltin diacetate, dioctyltin diacetate, dibutyltin-bis(4-methylaminobenzoate), dibutyltindilaurylmercaptide, dibutyltin-bis(6-methylaminocaproate), and the like, and combinations thereof.

In one embodiment, the catalyst can be an organotin catalyst selected from the group consisting of stannous octoate, dibutyltin dilaurate, dibutyltin diacetate, stannous oleate and combinations thereof. In another embodiment, the catalyst can be an organoamine catalyst, for example, tertiary amine such as trimethylamine, triethylamine, triethylenediamine, bis(2,2′-dimethylamino)ethyl ether, N-ethylmorpholine, diethylenetriamine, 1,8-Diazabicyclo[5.4.0]undec-7-ene and combinations thereof.

A blowing agent can be employed in the flexible polyurethane foam-forming mixture and/or in the preparation of the flexible polyurethane foam of the invention. These agents include, but are not limited to blowing agents, such as, linear or branched alkane hydrocarbons, e.g., butane, isobutane, 2,3-dimethylbutane, n- and isopentane and technical-grade pentane mixtures, n- and isohexanes, n- and isoheptane, methylene chloride and acetone. Other blowing agents can be used in combination with one or more of the previously mentioned blowing agents; these may be divided into the chemically active blowing agents which chemically react with the isocyanate or with other formulation ingredients to release a gas for foaming, and the physically active blowing agents which are gaseous at the exotherm foaming temperatures or less without the necessity for chemically reacting with the foam ingredients to provide a blowing gas. Included within the meaning of physically active blowing agents are those gases which are thermally unstable and decompose at elevated temperatures. Examples of chemically active blowing agents are preferably those which react with the isocyanate to liberate a gas, such as CO₂. Suitable chemically active blowing agents include, but are not limited to, water, mono- and polycarboxylic acids having a molecular weight of from 46 to 300, salts of these acids, and tertiary alcohols.

Alternatively, water and/or CO₂ may be used as the sole blowing agent(s) or as co-blowing agents with a hydrocarbon blowing agent. Water reacts with the organic isocyanate to liberate CO₂ gas which is the actual blowing agent. However, since water consumes isocyanate groups, an equivalent molar excess of isocyanate should be provided to make up for the consumed isocyanates.

Moreover, there can be employed optional components other than those mentioned above, for instance, other auxiliaries such as cross-linking agents, stabilizers, surfactants, pigments/dye(s), flame retardants, chain-extending agents, and fillers within a range which would not hinder the object of the present invention.

A surface-active agent is generally necessary for production of high grade polyurethane foam according to the present invention, since in the absence of same, the foams collapse or contain very large uneven cells. Numerous surface-active agents have been found satisfactory. Nonionic surface active agents are preferred. Of these, the nonionic surface-active agents such as the well-known silicones have been found particularly desirable. Other surface-active agents which are operative, although not preferred, include polyethylene glycol ethers of long chain alcohols, tertiary amine or alkanolamine salts of long chain alkyl acid sulfate esters, alkyl sulfonic esters, and alkyl arylsulfonic acids.

In one embodiment herein, the particular formulation of the flexible polyurethane foam-forming mixture can depend on the desired properties of the flexible polyurethane foam and can be adjusted as necessary by those skilled in the art and as described herein. The relative amounts of the flexible polyurethane foam-forming mixture component and the cyclic phosphate ester of formula (I) component of the inventive composition herein can also vary greatly depending on the desired properties of the flexible polyurethane foam made therefrom. Preferably, the composition of the present invention can comprise the flexible polyurethane foam-forming mixture component in an amount of from about 80 weight percent to about 99 weight percent, preferably from about 82 weight percent to about 97 weight percent, and most preferably from about 85 weight percent to about 95 weight percent, said weight percent being based on the total weight of the composition. In another embodiment herein the composition or the flame retardant additive composition of the present invention can comprise the cyclic phosphate ester of formula (I) component in an amount of from about 1 weight percent to about 20 weight percent, preferably from about 3 weight percent to about 18 weight percent, and most preferably from about 5 weight percent to about 15 weight percent, said weight percent being based on the total weight of the composition.

Methods for producing flexible polyurethane foam from the flexible polyurethane foam-forming composition of the present invention are not particularly limited. Various methods commonly used in the art may be employed. For example, various methods described in “Polyurethane Resin Handbook,” by Keiji Iwata, Nikkan Kogyo Shinbun, Ltd., 1987 may be used the contents of which are incorporated herein in their entirety. In one embodiment herein, the composition of the invention (also known as the flame retarded flexible polyurethane foam mixture) can be reacted to form preferably flexible polyurethane foam and more preferably low-density flexible polyurethane foam. In one embodiment herein, the flame retardant additive composition of the invention can be incorporated in a flexible polyurethane foam-forming mixture, as is described herein, to form flexible polyurethane foam, and more preferably low-density flexible polyurethane foam. In one embodiment herein the density of the low-density flexible polyurethane foam made from the composition or flame-retardant additive composition herein can be from about 0.1 to about 3.5, pounds per cubic foot (pcf), more preferably from about 0.5 to about 2.5 pcf and most preferably from about 0.8 to about 2.0 pcf. In an alternative embodiment herein, the composition or flame-retardant additive composition herein can be used to prepare flexible polyurethane foam with a density of from greater than 3.5 to about 50 pcf, more preferably from about 5 to about 50 pcf, and most preferably from about 12 to about 50 pcf.

In one embodiment herein the process of the invention as described herein, further comprises contacting at least one different liquid flame retardant (halogenated or non-halogenated as described above), with either or both components of the flame retarded flexible polyurethane foam mixture, prior to the formation of the flexible polyurethane flame retarded foam mixture; and/or, contacting at least one different liquid flame retardant with the formed flexible polyurethane flame retarded foam mixture during and/or after it is formed. In one embodiment herein the different liquid flame retardant is contacted with the cyclic phosphate ester of formula (I), and optionally stored as a flame retardant additive composition for a period prior to the contacting of such a flame retardant additive composition with the flexible polyurethane foam-forming mixture. In one embodiment such a combination can be stored until its intended use by an end-user to produce a flexible polyurethane foam.

In one embodiment herein, the flexible polyurethane foam herein can have preferably at least 80 percent recovery following compression set, more preferably at least 90 percent recovery following compression set and most preferably at least 95 percent recovery following compression set. Recovery is determined and reported as a percentage of the foam sample's original thickness after being placed between two metal plates, compressed to 90% of the sample's original thickness at 158° F. (70° C.) for 22 hours, then removed from the apparatus and allowed to recover for 30 minutes prior to remeasuring, as is well known in the art. Compression set testing is understood to comprise the standard as set out in ASTM D3574. In a more specific embodiment herein, the flexible polyurethane foam can have the above recited density and the above recited recovery. Still further, in another specific embodiment herein the flexible polyurethane foam herein can have an improved feel as compared to a flexible polyurethane foam containing a neopentyl cyclic phosphate ester, i.e., it may have the absence of any crunchy feel upon compression. A polyurethane foam, e.g., a low density polyurethane foam made with a neopentyl cyclic phosphate ester of the formula (I), i.e., where both R¹ and R² are methyl (which is outside the scope of the present invention), will have virtually no recovery from its original compressed state, i.e., remaining 85-90% compressed.

In one embodiment herein it will be understood that absence of melamine compound(s) can comprise the complete absence of melamine compound(s).

The expression “effective flame retarding amount” can vary greatly depending on the specific cyclic phosphate ester, the optional different liquid flame retardant, and the contents of the polyurethane foam-forming mixture as well as the desired end properties of the flexible polyurethane foam and the desired use of such foam. In one embodiment herein the expression “effective flame retarding amount” can comprise any amount of cyclic phosphate ester of the formula (I) and, optionally, different liquid flame retardant that can provide a flame retardant pass of California TB117 and MVSS302. In another embodiment herein the expression “effective flame retarding amount” can comprise the amounts of cyclic phosphate ester of the formula (I) and, optionally different liquid flame retardant in the amounts and ratios described herein.

In one embodiment the flexible polyurethane foam will have improved flame retardant properties as compared to a polyurethane foam-fouuing mixture that does not contain the cyclic phosphate ester of formula (I).

The flame retardant composition(s) (inclusive of flame-retardant additive composition) herein can be used to produce flame-retarded flexible polyurethane foam, which can be used in applications such as padding, upholstery, automobile applications, insulation and the like.

The following examples are offered to illustrate the general nature of the invention. Those skilled in the art will appreciate that they are not limiting to the scope and spirit of the invention and various and obvious modifications will occur to those skilled in the art. All parts are by weight unless otherwise stated.

### EXAMPLES

### Synthesis of 5-butyl-5-ethyl-2-phenoxy-1,3,2-dioxaphosphorinane2-oxide (BEPDO)

BEPDO was prepared from monophenyl chlorophosphate (MPCP) and 2-butyl-2-ethyl-1,3-propanediol. MPCP (854.5 g, 4.05 mol) was placed in a 2 liter reactor with an agitator, a thermometer, a nitrogen inlet, and a condenser connected to a HCl scrubber/vacuum system.

After heating the reactor to 50° C. and pulling vacuum to 350 mmHg, 2-butyl-2-ethyl-1,3-propanediol (649.0 g, 4.05 mol) was slowly added dropwise to the reactor over a two hour period at ˜5.4 grams/minute. The temperature of the reaction was controlled at 50° C. during the addition. After completing a one hour post-addition hold period at 350 mmHg and 50° C., the vacuum on the reaction system was gradually increased to 200 mmHg and the reaction held for an additional two hours. After reaction completion, the vacuum of the system was again increased to 75-100 mmHg for one hour to remove any remaining HCl. Reaction completion was determined by the disappearance of MPCP in the ³¹P NMR spectra.

The reaction mixture was then washed with 5% NaOH at 60° C. until a basic pH was obtained, followed by several water washes until a neutral pH was obtained. Any remaining water was then removed from the product on a vacuum rotary evaporator. The product (BEPDO) was isolated in 94.7% yield (1144 grams) with purity greater than 99% and an acid number of 0.004 mg KOH/g.

The following flame retardant test data were generated using a typical polyether polyurethane flexible foam, as described below, that was tested at nominal densities of 1.0 and 1.8 pounds per cubic foot. The following standard tests were employed:
A. California TB 117—Part A Test: This test is a small-scale vertical test with a twelve second ignition time. The ignition source is removed after twelve seconds. A second clock is started if the sample continues to burn. The criteria for failing includes, 1) an individual test sample with a burn length exceeding eight inches, 2) all test samples with an average burn length exceeding six inches, 3) individual test sample will an afterflame or afterglow exceeding ten seconds or 4) all test samples with an average afterflame or afterglow exceeding five seconds.

B. California TB 117—Part D Test: This test is a smoldering test in which a cigarette is used as the ignition source under a cloth cover. The foam sample is covered with a standard velvet cotton cloth and placed in a small wooden frame to form a mock chair. The back of the sample is 8″×7″×2″ and the seat is 8″×4″×2″. The sample is preweighed before testing and again weighed after the test is completed. If the foam losses more than 20% of its weight, it is judged to be a failure.

C. MVSS 302 Test: This test is a horizontal flame test that is used as a guideline for automobile manufacturers. The sample size is 14″×4″×½″. There is a line 1½’ from the ignition point. A flame is ignited for fifteen seconds, The ignition source is then turned off and the sample rated. A “DNI” (did not ignite) rating indicates that the sample did not support combustion. A rating of “SE” indicates that the sample ignited but did not burn to the timing zone, which is a point starting from the 1½″ mark to the 3½″line. A rating of “SENBR” indicates that the sample burned past the 1½″ line but was extinguished before the 3½″ mark. A rating of “SE/B” indicates that the sample burned past the 3½″ mark but was extinguished before the endpoint. An inch per minute rate is then calculated. The burn rate indicates that a sample burned past the 3½″ mark. An indication of a burn rate or a SE/B rating that was higher than 4.0 in/min, indicates failure in accordance with this test. For this study a minimum performance of SENBR was required.

The units in the table below are parts per hundred polyol (pphp)

Polyurethane Foam-Forming Reaction - General Formulation

| | | FOAM |
|---|---|---|
| | ADDITION | DENSITY |
| COMPONENT | LEVEL | RANGE (lb/ft³) |
| Vorinol 3136 (polyether polyol with | 100 | 1.0 and 1.8 |
| an OH number of 54, available | | |
| from Dow) | | |
| FR (flame retardant available from | variable | 1.0 and 1.8 |
| ICL Supresta Inc.) flame retardant of | | |
| formula (I) | | |
| H₂O | 5.6 and 3.5 | 1.0 and 1.8 |
| Methylene Chloride* | 10 | 1.0* |
| D33LV/A-1 = 3/1 ratio (Dabco BLV | 0.22 | 1.0 and 1.8 |
| catalyst available from Air Products) | | |
| Silicone L-620 (Niax Silicone L-620 | 0.80 and 1.20 | 1.0 and 1.8 |
| available from Momentive) | | |
| Stannous Octoate T-10 (Dabco T-10 | 0.4 and 0.6 | 1.0 and 1.8 |
| available from Air Products) | | |
| TDI (Mondur TD-80 Grade A | 71.0 and 46.0 | 1.0 and 1.8 |
| available from Bayer Material | | |
| Science) | | |
| TDI Index | 110 | 1.0 and 1.8 |

*Used in 1.0 lb/ft³ foams only

In the above table, the water, the silicone, the catalyst and TDI are recited in the amounts used in the first number at 1.0 lb/ft³ foam, while the second number is for 1.8 lb/ft³ foam. If the addition level is an exact number, then it is the same value for both 1.0 and 1.8 density foam. The values of 1.0 and 1.8 indicate those respective foam densities for the respective polyurethane formulations.

Flammability Data - California TB117

| | Density | Loading | Airflow | Initial | Aged | Smolder |
|---|---|---|---|---|---|---|
| FR | (lb/ft³) | (pphp) | (cfm) | (inches) | (inches) | (wt. %) |
| Fyrol ® HF-4 | 1.0 | 20 | 5.4 | 5.2 | 5.4 | 99 |
| BEPDO | 1.0 | 16 | 5.5 | 3.7 | 4.0 | 98 |
| BEPDO/71B | 1.0 | 18 | 5.2 | 4.4 | 4.7 | 99 |
| (50/50) | | | | | | |
| Fyrol ® HF-4 | 1.8 | 15 | 4.1 | 4.5 | 4.8 | 90 |
| BEPDO | 1.8 | 10 | 4.4 | 2.9 | 3.0 | 91 |
| BEPDO/71B | 1.8 | 10 | 3.7 | 3.8 | 4.2 | 93 |
| (50/50) | | | | | | |

71B = Phosflex ® 71B = commercial t-butylated phenyl phosphate ester blend

Flammability Data - MVSS 302

| | Density | Loading | Airflow | MVSS 302 |
|---|---|---|---|---|
| FR | (lb/ft³) | (pphp) | (cfm) | (rating/length) |
| Fyrol ® HF-4 | 1.8 | 15 | 4.1 | SENBR |
| | | | | (1.70 inches) |
| BEPDO | 1.8 | 10 | 4.4 | SENBR |
| | | | | (0.25 inches) |
| BEPDO/71B (50/50) | 1.8 | 10 | 3.7 | SENBR |
| | | | | (0.30 inches) |

71B = Phosflex ® 71B = commercial t-butylated phenyl phosphate ester blend

Fyrol® HF-4 is a commercial halogen-free FR product available from ICL Supresta Inc. which is an aryl phosphate ester blend product. As can be seen, the data for BEPDO is much improved in both the Cal 117 and MVSS 302 tests over that observed for the current commercial product.

While the process of the invention has been described with reference to certain embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out the process of the invention but that the invention will include all embodiments falling within the scope of the appended claims.

1. A composition comprising;
(a) a flexible polyurethane foam-forming mixture and;
(c) an effective flame retarding amount of at least one non halogen-containing cyclic phosphate ester of the general formula (I): 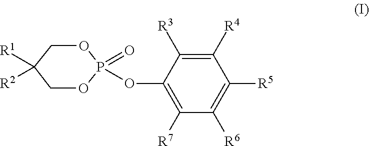
wherein R¹ and R², are the same or different, linear or branched alkyl group containing from up to about 10 carbon atoms, provided that R¹ and R² are not both methyl, optionally containing heteroatom substituents; and R³-R⁷ are each independently hydrogen or the same or different linear or branched alkyl group containing up to about 4 carbon atoms, optionally containing heteroatom substituents; provided that the cyclic phosphate ester is a liquid or is substantially soluble in at least one different liquid flame retardant and/or the hydroxyl-containing component of the flexible polyurethane foam-forming mixture; and, provided that the composition contains at least 8.5 weight percent phosphorous based on the total weight of any phosphorous-containing component(s) and the composition is in the absence of a melamine compound.

2. The composition of claim 1 wherein R¹ is methyl and R² is a linear or branched alkyl containing from 3 to about 9 carbon atoms.

3. The composition of claim 1 wherein R¹ is ethyl and R² is a linear or branched alkyl containing from 3 to about 8 carbon atoms.

4. The composition of claim 1 wherein R¹ is propyl or isopropyl and R² is a linear or branched alkyl containing from 4 to about 7 carbon atoms.

5. The composition of claim 1 wherein R¹ is selected from the group consisting of butyl, isobutyl, sec-butyl and, tert-butyl and R² is a linear or branched alkyl containing from 4 to about 6 carbon atoms.

6. The composition of claim 1 wherein R¹ is selected from the group consisting of pentyl, 2-pentyl, 2-methylbutyl, isopentyl and neopentyl, and R² is a linear or branched alkyl containing 5 carbon atoms.

7. The composition of claim 1 wherein R¹ is ethyl, R² is n-butyl, and R³-R⁷ are each independently hydrogen, methyl, isopropyl or butyl.

8. The composition of claim 1 wherein R¹ is ethyl, R² is n-butyl and R³-R⁷ are all hydrogen.

9. The composition of claim 1 wherein the polyurethane foam-forming mixture comprises a hydroxyl-containing component, an isocyanate component and a catalyst

10. The composition of claim 1 further comprising at least one different liquid flame retardant.

11. The composition of claim 10 wherein the at least one different liquid flame retardant is selected from the group consisting of alkyl phosphates, aryl phosphates, alkyl aryl phosphates, alkaryl phosphates, aromatic bisphosphates, oligomeric phosphates, phosphonates, and combinations thereof.

12. A flame retardant additive composition comprising an effective flame retarding amount of a mixture of
(a) at least one non halogen-containing cyclic phosphate ester of the general formula (I): 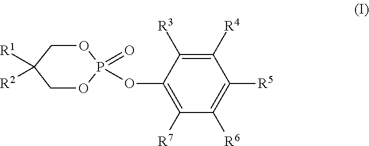
wherein R¹ and R², are the same or different, linear or branched alkyl group containing up to about 10 carbon atoms, provided that R¹ and R² are not both methyl, optionally containing heteroatom substituents; and R³-R⁷ are each independently hydrogen or the same or different linear or branched alkyl group containing up to about 4 carbon atoms, optionally containing heteroatom substituents; and,
(b) at least one different liquid flame retardant; provided that the cyclic phosphate ester of formula (I) is a liquid or is substantially soluble in the at least one different liquid flame retardant and/or a hydroxyl-containing component of a flexible polyurethane foam-forming mixture; and, provided that the flame retardant composition is in the absence of a melamine compound and the flame retardant composition contains at least 8.5 weight percent phosphorous based on the total weight of any phosphorous containing component(s).

13. The composition of claim 12 wherein R¹ is methyl and R² is a linear or branched alkyl containing from 3 to about 9 carbon atoms.

14. The composition of claim 12 wherein R¹ is ethyl and R² is a linear or branched alkyl containing from 3 to about 8 carbon atoms.

15. The composition of claim 12 wherein R¹ is propyl or isopropyl and R² is a linear or branched alkyl containing from 4 to about 7 carbon atoms.

16. The composition of claim 12 wherein R¹ is selected from the group consisting of butyl, isobutyl, sec-butyl and, tert-butyl and R² is a linear or branched alkyl containing from 4 to about 6 carbon atoms.

17. The composition of claim 12 wherein R¹ is selected from the group consisting of pentyl, 2-pentyl, 2-methylbutyl, isopentyl and neopentyl, and R² is a linear or branched alkyl containing 5 carbon atoms.

18. The composition of claim 12 wherein R¹ is ethyl, R² is n-butyl, and R³-R⁷ are each independently hydrogen, methyl, isopropyl or butyl.

19. The composition of claim 12 wherein R¹ is ethyl, R² is n-butyl, and R³-R⁷ are each hydrogen.

20. The composition of claim 12 wherein the at least one different liquid flame retardant is selected from the group consisting of alkyl phosphates, aryl phosphates, alkyl aryl phosphates, alkaryl phosphates, aromatic bisphosphates, oligomeric phosphates, phosphonates, and combinations thereof.

21. A flexible polyurethane foam comprising the composition of claim 1.

22. A flexible polyurethane foam comprising the composition of claim 7.

23. A flexible polyurethane foam comprising the composition of claim 12.

24. A flexible polyurethane foam comprising the composition of claim 18.

25. The flexible polyurethane foam of claim 21 having a density of less than about 1.5 pcf, and having at least 80 percent recovery following compression set.

26. The flexible polyurethane foam of claim 23 having a density of less than about 1.5 pcf, and having at least 80 percent recovery following compression set.

27. A process of making a flame retarded flexible polyurethane foam mixture comprising contacting a flexible polyurethane foam-forming mixture and an effective flame retarding amount of at least one non halogen-containing cyclic phosphate ester having the general formula (I): 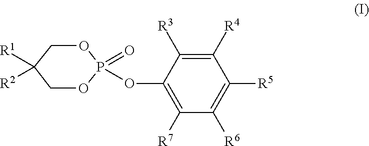
wherein R¹ and R², are the same or different, linear or branched alkyl group containing up to about 10 carbon atoms, optionally containing heteroatom substituents, provided that R¹ and R² are not both methyl; and R³-R⁷ are each independently hydrogen or the same or different linear or branched alkyl group containing up to about 4 carbon atoms, optionally containing heteroatom substituents; provided that the cyclic phosphate ester is a liquid or is substantially soluble in a different liquid flame retardant and/or the hydroxyl-containing component of the flexible polyurethane foam-forming mixture; which contacting forms said flame retarded flexible polyurethane foam mixture; and, provided that the flame retarded flexible polyurethane foam mixture is in the absence of a melamine compound and the flame retarded foam mixture contains at least 8.5 weight percent phosphorous based on the total weight of any phosphorous containing component(s).

28. The process of claim 27 further comprising contacting at least one different liquid flame retardant, with either or both components of the flexible polyurethane flame retarded foam mixture, prior to the formation of the flexible polyurethane flame retarded foam mixture; and/or, contacting at least one different liquid flame retardant with the formed flexible polyurethane flame retarded foam mixture.

29. The process of claim 27 further comprising reacting the flame retarded flexible polyurethane foam mixture to form flexible polyurethane foam.

30. A flexible polyurethane foam made by the process of claim 29.
